(19) United States
(12) Patent Application Publication
(10) Pub. No.: US 2011/0239892 A1
(43) Pub. Date: Oct. 6, 2011

(54) FILTER DEVICE AND GAS GENERATOR HAVING A FILTER DEVICE

(75) Inventor: Gerrit VON BREITENBACH, Karlstein (DE)

(73) Assignee: TAKATA-PETRI AG

(21) Appl. No.: 13/160,436

(22) Filed: Jun. 14, 2011

Related U.S. Application Data
(63) Continuation of application No. PCT/EP2010/054075, filed on Mar. 29, 2010.

(30) Foreign Application Priority Data
Mar. 31, 2009 (DE) 10 2009 015 217.2

(51) Int. Cl. B60R 21/264; B01D 46/42; C06D 5/00; B01J 7/00

(52) U.S. Cl. 102/530; 55/414

(57) ABSTRACT

A filter device for filtering a gas flow is provided. The filter device having a wound or folded filter material web. It is provided that at least one end of the filter material web has or is connected to a section which is formed by a closed sheet metal section, wherein the closed sheet metal section has at least one recess for the inflow or outflow of gas into or out of the filter device.

### CROSS-REFERENCE TO A RELATED APPLICATION

This application is a continuation of International Patent Application Number PCT/EP2010/054075, filed on Mar. 29, 2010, which was published in German as WO 2010/112450 A1. The foregoing international application is incorporated by reference herein.

### BACKGROUND

The invention relates to a filter device for filtering a gas flow and a gas generator having such a filter device.

From the publication EP 0 552 706 B1 a filter device is known, in which a filter element, made of several filter material layers of different permeability, is designed as winding body, which is formed by winding a filter material web. Thereby filter sections with different permeability are made available.

Publication DE 10 2004 032 609 B4 specifies a filter- and cooling unit, in which a plurality of disc-shaped, metallic individual filter elements are stacked into a filter.

It is further known, for the improvement of the filter utilization in gas generators in thermal terms as well as in terms of particle retention, to combine filters with baffle plates, which are employed in such a way that they guide through the gas flow, generated by a gas generator, in a directed way through the filter and thus improve the filter utilization. Such arrangements, which are also called baffled filter or baffled filter design, are realized in connection with wire mesh filters which are, however, expensive to manufacture and relatively costly. Also, in the manufacturing process it is difficult to control the regularity of the wire mesh over the circumference and the length of the filter. Additionally, the assembly of the baffle plates means an additional expenditure.

### SUMMARY

The object underlying the present invention is to make available a filter device and a gas generator, which allow for a good filter utilization due to the use of baffle plates, while, however, being simple to manufacture.

The solution according to the invention provides a filter device which is manufactured by a wound or folded filter material web. Here at the least one end of the filter material web is connected to a closed sheet metal section or forms such a closed sheet metal section. The closed sheet metal section has at least one recess for the inflow or outflow of gas into or out of the filter device.

The solution according to the invention allows the use of conventional wound filters, which are formed for instance from expanded metal sheets. With the closed sheet metal sections baffle plates are integrated into the filter, which guide through a gas flow in a directed way through the filter and hereby improve the filter utilization in thermal terms as well as in terms of particle retention. The guide elements designed as sheet metal sections of the filter material web here do not have to be assembled separately, because they are integrated in the filter material web or are connected to said filter material web, such that upon the winding or folding of the filter material web the sheet metals are automatically positioned suitably. With that, a filter device with integrated baffle plates and without the necessity of separate baffle plate components and their assembly is made available.

The solution according to the invention leads to an improved filter utilization, because the integrated sheet metal sections guide a gas flow, through the recesses or openings formed in these said sheet metal sections, in a directed way through the filter and therefore improve the filter utilization. At the same time, the actual filter itself can be manufactured from conventional wound filters, without the necessity to have to fall back upon relatively costly and expensive wire mesh filters. For instance, the filters are formed by expanded metal sheets or sheet metals which are stamped or embossed or are designed with structures. The filter material web can here be made of one or several layers of such sheet metals, which are then wound together.

The solution according to the invention has the further advantage that there is only a small assembly expenditure, because the baffle plates do not have to be arranged and assembled separately. Due to the elimination of baffle plate components themselves there is, above that, also a weight reduction. Also, due to the reduced number of parts a quality control can take place with reduced expenditure.

The wound filter material web forms a hollow cylindrical winding body of the filter device, wherein a closed sheet metal section forms the inner or outer shell surface of the winding body or at the least a part thereof. The hollow cylindrical winding body is here flowed through radially from inside outwards by a gas flow which is to be purified.

In one exemplary embodiment both ends of the filter material web are each connected to a closed sheet metal section, respectively. Basically, it is, however, also possible, to merely connect one end of the filter material web with a closed sheet metal section, wherein then either one dispenses with a baffle plate in the area of the other end of the filter material web or such a baffle plate is separately assembled in the usual manner.

In so far as two closed sheet metal sections are provided as baffle plates, one sheet metal section forms the inner and the other sheet metal section forms the outer shell surface of the hollow cylindrical winding body. A component, directed in longitudinal direction of the winding body, can here be added to the radial flow of the gas flow, which is to be purified, running from inside outwards in the hollow cylindrical winding body, by designing the recesses in both sheet metal sections to be off-set to each other.

As far as the embodiment of the recesses is concerned, numerous possibilities for the realization are conceivable in this case. What matters is merely to allow for an entry of air into the actual filter itself in a defined manner. Corresponding recesses in the sheet metal sections can be formed for instance as holes and/or as material cut-outs or indentations on the edge. Here it has to be taken into account that such recesses merely serve the directed influx or the directed outflow of gas into or out of the filter device. The recesses are, on account of their number and/or their size, not suited to form a filter element themselves. They are essentially closed baffle plates, which are adjacent to the actual filter material of the filter material web itself.

In one exemplary embodiment of the invention it is provided that the sheet metal section or the sheet metal sections represent separately manufactured parts, which are connected to the filter material web. For this purpose they are for instance welded with the filter material web. It is, however, equally within the scope of the invention that the sheet metal section or the sheet metal sections form one piece with the filter material web.

In the latter case it is for instance provided that the filter device has a sheet metal strip, which in the area of the filter material web is stamped and/or embossed and/or forms three-dimensional structural elements, such that the filter material web in its wound state acts as filter. The sheet metal strip in the area of the sheet metal sections, on the other hand, is formed closed except for the at least one recess for the inflow or outflow of gas and forms a baffle plate for the gas which is to be purified. Also, several such sheet metal strips can be arranged one upon the other and can be wound together.

The invention furthermore relates to a gas generator of a vehicle occupant protection device, having a filter. Such a filter is for instance arranged in a cylindrical generator casing. Gases, generated in a combustion chamber of the gas generator, flow through the filter and leave the generator casing purified through outlet openings which are formed in said filter.

### BRIEF DESCRIPTION OF THE DRAWINGS

The invention will subsequently be explained more closely with reference to the Figures of the drawing with the help of several exemplary embodiments.

FIG. 1A shows a filter material web, spread out flat, having integrated gas baffle plates in top view.

FIG. 1B shows in sectional view the wound filter material web of FIG. 1A, which forms a hollow cylindrical winding body.

FIG. 2A shows a spread-out filter material web according to prior art.

FIG. 2B shows the filter material web of FIG. 2A in its wound state.

FIGS. 3A, 3B shows embodiments of integrated gas baffle plates, in which recesses for the inflow or outflow of gas are formed as material cut-outs on the edge.

FIGS. 4A, 4B shows embodiments of integrated gas baffle plates, in which recesses for the inflow or outflow of gas are formed as indentations on the edge.

FIGS. 5A, 5B shows embodiments of integrated gas baffle plates, in which recesses for the inflow or outflow of gas are formed as circular gas passage openings.

FIG. 6 shows in top view an alternative embodiment of a filter material web, which is formed by stamped circular holes.

FIG. 7 shows in top view a further alternative embodiment of a filter material web, which is formed by triangular stamped holes.

FIG. 8 shows in side view a further alternative embodiment of a filter material web, which is formed by a sheet metal with an embossed structure.

FIG. 9 shows in sectional view a further alternative embodiment of a filter material web, which is formed by a textured sheet metal with three-dimensional structural elements.

FIG. 10 shows in sectional view a further alternative embodiment of a filter material web which is formed by a textured sheet metal with punched hoods.

FIG. 11 shows in sectional view a first exemplary embodiment of a gas generator having a wound filter device according to FIG. 1B.

FIG. 12 shows in sectional view a second exemplary embodiment of a gas generator having a wound filter device according to FIG. 1B.

### DETAILED DESCRIPTION

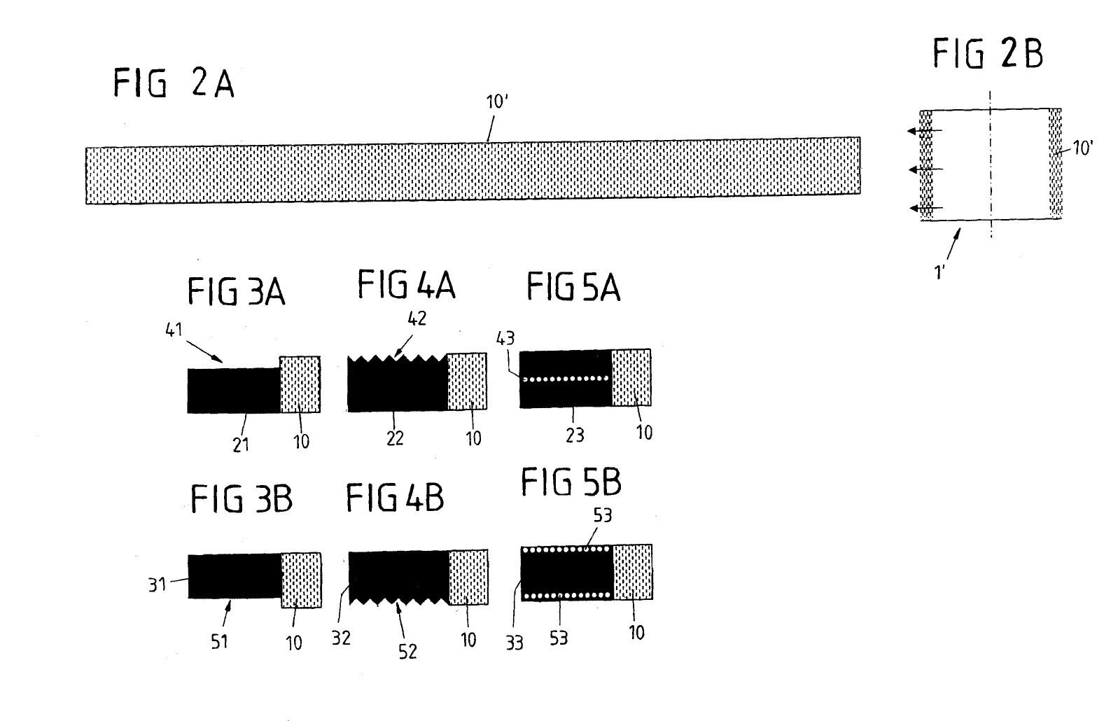

For a better understanding of the present invention, first a filter according to prior art is explained with the help of FIGS. 2A, 2B. FIG. 2A shows an unrolled filter material web 10′, spread out flat, with rectangular measurements. By rolling the filter material web 10′ along its longitudinal direction, a hollow cylindrical winding body 1′ is produced, which farms the filter and is illustrated in FIG. 2B. The passage of air through the hollow cylindrical winding body takes place in radial direction as is indicated by the arrows of FIG. 2B. The filter material web is made of a conventional filter material such as for instance a strip of expanded metal. This can be formed by one or multiple layers. By winding the strip of expanded metal the filter of FIG. 2B is produced.

Expanded metal, in the sense of the present invention, is here generally understood to be a basic material with openings in the surface which are produced by off-set cuts without loss of material under simultaneous expanding reshaping. The meshes of such a latticed material are here neither wire-woven nor welded. Apart from the term expanded metal the term expanded metal mesh is also used.

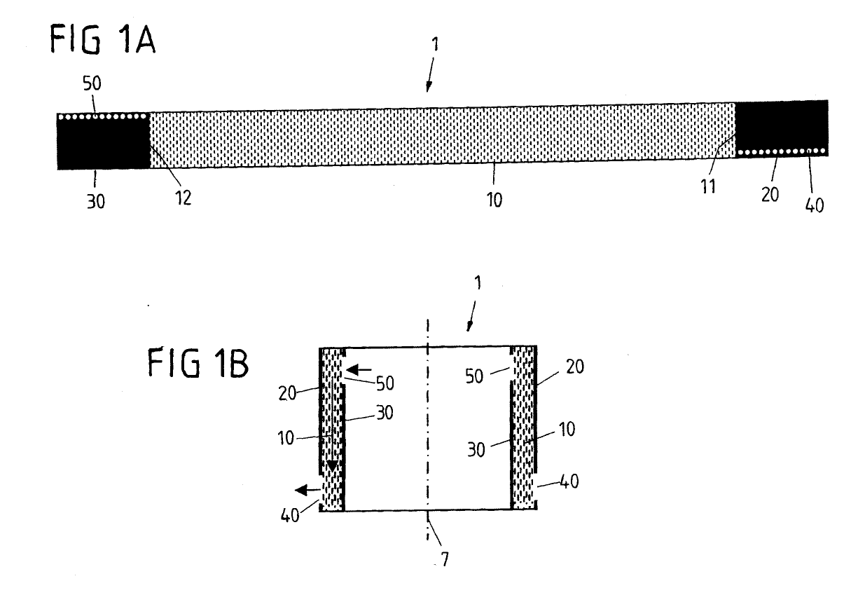

FIG. 1A shows an unrolled, longitudinally spread-out filter 1. The filter 1 has a filter material web 10, which can be made of any filter material that can be wound. For instance the filter material web 10 is made of one or several expanded metal sheets fixed onto each other. The filter material web 10 is designed rectangular and possesses two narrow sides or ends 11, 12. Furthermore, the filter 1 has two closed sheet metal sections 30, 40, which are each fixed onto the ends 11, 12 of the filter material web 1, respectively. This takes place for instance by welding. The sheet metal sections 20, 30 here have the same width as the filter material web 10 such that the filter material web 10 and the sheet metal sections 20, 30 together form an elongated, rectangular filter web. The closed sheet metal sections 20, 30 are therefore integral parts of the filter 1.

In the sheet metal sections 20, 30 of the filter 1 recesses 40, 50 are formed, respectively. In the exemplary embodiment of FIG. 1A the recesses are formed as a plurality of circular holes 40, 50, which extend on the lower edge of the one sheet metal section 20 and on the upper edge of the other sheet metal section 30, each along a straight line. As will be explained, these recesses 40, 50 serve the defined inflow or outflow of gas into the filter 1.

FIG. 1B shows the wound filter 1 which is produced by winding of the filter web of FIG. 1A. Here it has to be taken into account that the sheet metal sections 20, 30 of the filter web are also wound. During the winding process a hollow cylindrical winding body is formed which forms the filter 1. On account of the winding also of the sheet metal sections 20, 30 the inner shell surface of the hollow cylindrical body is formed by the one sheet metal section 30 and the outer shell surface of the hollow cylindrical body is formed by the other sheet metal section 20.

The recesses 40, 50, formed in the sheet metal sections 20, 30, which said recesses 40, 50 referring to the longitudinal axis 7 of the hollow cylinder or of the filter 1 are off-set to each other, generate a directed gas flow through the filter 1. The off-set between the openings 40, 50 here causes that, according to FIG. 1B, gas, generated inside of the hollow cylinder, first enters through the openings 50 of the one sheet metal section 30 radially outwards into the filter, in this said filter it then undergoes, in addition to a movement directed radially outwards, a movement in longitudinal direction of the filter axis 7 and then leaves the filter through the openings 40 in the outer sheet metal section 20 in radial direction. Through the sheet metal sections 20, 30 the gas flow is thus guided in a directed way and, in comparison to purely radially flowing through, with a longer filter path through the filter 1, such that an improved filter utilization is present. This is the case in thermal regard as well as in regard to particle retention because the longer flow-through path of the gas, which is to be purified, through the filter 1 allows for, for one thing, an improved heat transfer onto the filter and, for another, a better particle retention.

The sheet metal sections 20, 30 therefore make baffle plates available which guide through the gas flow in a directed way through the filter 1 and which are here integral parts of the filter 1. Upon manufacturing the filter from the filter web of FIG. 1A the baffle plates 20, are automatically made available and adjusted.

In one embodiment the length of a sheet metal section 20, 30 essentially corresponds to the circumferential length of the hollow cylindrical body, which said body is formed by the filter web. In this case, areas of a sheet metal section 20, 30 do not overlap. Basically, it can, however, also be provided that a sheet metal section 20, 30 has such a length that it forms overlapping areas after the winding process. The openings, framed in the sheet metal section, are in this case preferably adjusted in such a way that they are in alignment in the sections which lie one upon the other.

FIGS. 3A, 3B, 4A, 4B and 5A, 5B show different exemplary embodiments of integrated gas baffle plates. Here there are recesses 41, 51, 42, 52, 43, 53 provided each in the sheet metal sections 21, 31, 22, 32, 23, 33, respectively, which are off-set to each other, such that a directed, not purely radially adjusted gas flow takes place through the filter.

In the embodiment of FIGS. 3A, 3B the recess for the inflow or outflow of gas in the filter is formed as material cut-out 41, 51 on the edge. The respective sheet metal section 21, 31 has for this purpose, adjacent to the filter material web 10, a lesser width in comparison to the width of the filter material web 10.

In the embodiment of FIGS. 4A, 4B the recesses 42, 52 for the inflow or outflow of gas are likewise formed on the sheet metal section on the edge. The recesses 42, 52 are here provided as a zigzag-shaped rim with corresponding indentations. Recesses 41, 51, 42, 52 on the edge according to FIGS. 3A, 3B, 4A, 4B have the advantage of a relatively simple manufacture.

In the embodiment of FIGS. 5A, 5B, similar to the embodiment of FIGS. 1A, 1B, circular holes 43, 53 are formed in the sheet metal sections 23, 33, which said holes each run along a line which is extending in longitudinal direction of the sheet metal section. As opposed to the embodiment of FIGS. 1A, 1B a row of holes 43, arranged in the middle, is here provided in the one sheet metal section 23. In the other sheet metal section 33 two rows of holes 53 on the edge are provided. Hereby it is achieved that the gas flow in the filter branches out and for instance flows from the holes 43, arranged in the middle, upwards as well as downwards to the holes 53.

In the exemplary embodiments explained above the sheet metal sections 20-23, 30-33, each illustrated respectively, are fixed on to a filter material web 10. In this respect, these are sheet metals, separately manufactured with regard to the filter material web 10, which are in a separate process connected to the filter material web 10 for the manufacture of the total web illustrated in FIG. 1A. It is, however, equally within the scope of the invention that the filter material web 10 and the sheet metal sections 20, 30 confining it form one piece.

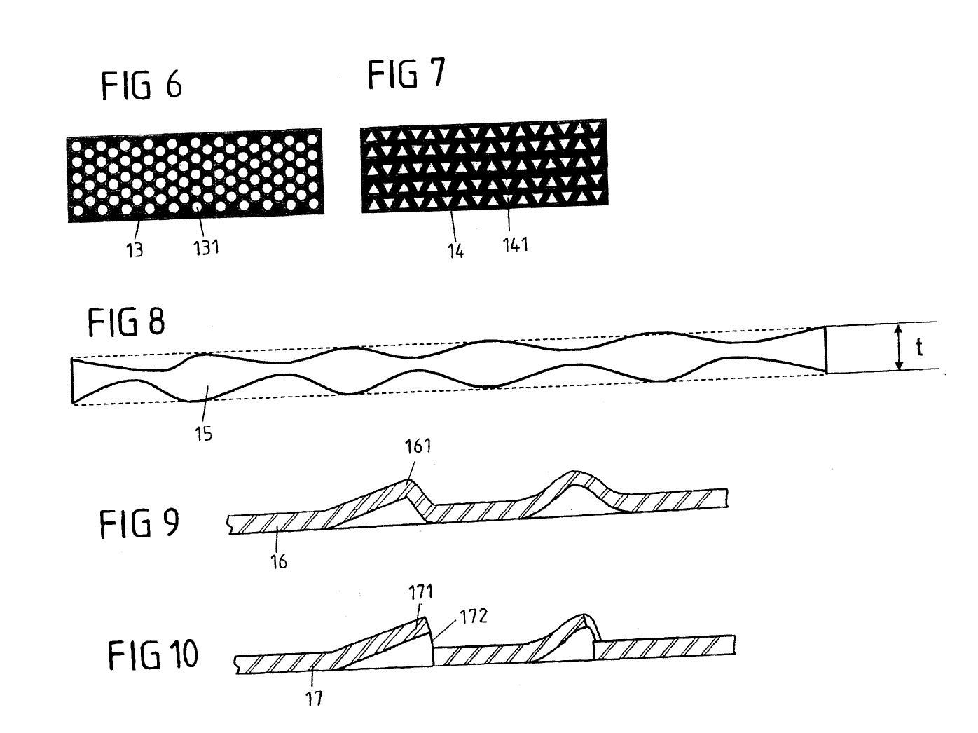

FIGS. 6 to 10 show alternative embodiments for the semi-finished products for the manufacture of wound filters according to the invention. Here it is pointed out in advance that in FIGS. 6 to 10 the lateral closed sheet metal sections are not separately illustrated. But these are in those embodiments equally present, while, however, forming one piece with the actual filter material web itself. The forming can take place corresponding to FIGS. 1A to 5B.

A section of the unrolled filter here qualifies as filter material or as gas baffle plate depending on whether or not filter structures are formed in the semi-finished product. In the sheet metal sections forming the gas baffle plates no filter structures are provided. They are rather closed sheet metal sections, which merely have recesses for the inflow or outflow of gas.

According to the embodiment of FIG. 6, as semi-finished product for the manufacture of a wound filter, a perforated plate 13 with stamped holes 131 is provided, which are for instance, however not necessarily, formed circular. The stamped holes are here formed only in the area of the filter material web 13, not in the closed sheet metal sections (not illustrated). In the embodiment of FIG. 7 the filter material web is designed as perforated plate 14 having punchings in the shape of triangles 141. Of course, other punchings are likewise possible.

In the exemplary embodiment of FIG. 8 the filter material web 15 has an embossed structure with a change of wall thickness Δt in the direction of the sheet metal plane. Due to the change of wall thickness channels for the gas flow in the filter are produced in the wound sheet metal.

In the embodiment of FIG. 9 the filter material web 16 is formed as textured sheet metal which has three-dimensional miniature-structural elements 161. These can be formed one-sided or two-sided, drawn, profiled, rolled, hydro-formed and so on. Due to the structural elements 161, again, channels for air flow in the filter are produced.

The above-mentioned measures for forming a filter such as stamping, embossing and structuring of a sheet metal can be combined at will. For instance, in FIG. 10 an exemplary embodiment is illustrated, in which a filter material web 17 forms punched hoods 171, wherein the hoods 171 form three-dimensional miniature-structural elements as well as make openings 172 available.

The sheet metals can for instance be steel sheets, aluminium sheets or copper sheets.

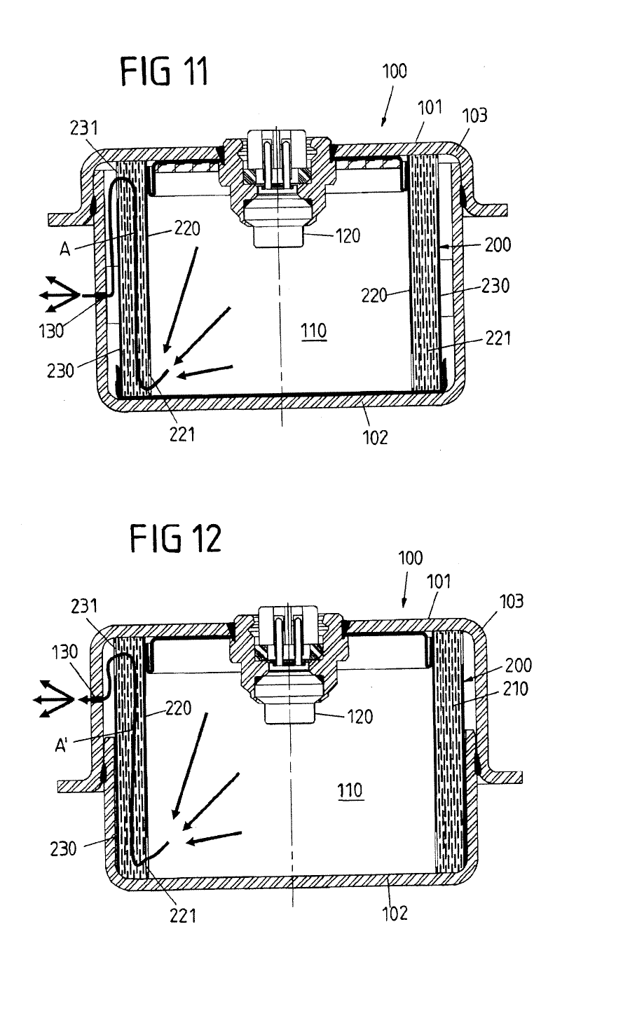

It is pointed out that the specified filter 1 having integrated gas baffle plates 20, 30 can basically be employed in any context, for instance in household or rocket technology. A preferred implementation takes place in a gas generator of a vehicle occupant protection device. Examples of such implementations are illustrated in FIGS. 11 and 12.

FIG. 11 shows in sectional view a gas generator 100, constructed rotationally symmetric, having a generator casing 101 made of a generator tub 102 and a generator cover 103 connected to it. Inside the generator casing 101 a combustion chamber 110 is designed, in which an ignition element 120, an ignition charge and fuel means (not illustrated) are located. The interior of the gas generator 100, which in FIG. 11 is illustrated merely schematically, can here be subdivided into several chambers, for instance an ignition chamber, arranged in the middle, followed by the actual combustion chamber itself and thereupon followed by a separation chamber. The specific configuration of the gas generator 100 is here presently not the matter of concern.

Inside the generator casing 101 a wound filter 200 is located, which is designed for instance corresponding to FIGS. 1A, 1B. The filter 200 has a filter material 210 which can be wound, an inner integrated baffle plate 220 and an outer integrated baffle plate 230. In the inner integrated baffle plate 220 lower recesses 221 are realized and in the outer integrated baffle plate 230 upper recesses 231 are realized.

After igniting the fuel means, located in the combustion chamber 110, gas is produced. The generated gas flows through the lower recesses 221 of the inner baffle plate 220 into the filter material 210 and in said filter material, as schematically illustrated by the gas flow line A, in longitudinal direction through the filter. An the upper recesses 231 of the outer baffle plate 230 the gas flow leaves the filter 100 purified and cooled. The purified and cooled gas then leaves the generator casing 101 through lateral outlet openings 130, formed in the generator tub 102.

The exemplary embodiment of FIG. 12 differs from the exemplary embodiment of FIG. 11 in that the generator tub 102 is formed more flat and, to compensate, the generator cover 103 extends more strongly in the direction of the generator tub 102. The gas flow A′ is such that the outlet openings 130 in the generator cover 103 are formed in the upper area of the generator casing.

The invention is in its embodiment not restricted to the exemplary embodiments illustrated above. For instance, the integrated baffle plates can have a different shape from the one illustrated and/or be furnished in another manner with recesses for the inflow or outflow of gas into or out of the filter. The invention is further not restricted to specific filter materials as long as these can be wound. It can also be provided that the filter has not wound but instead folded filter material webs. In that case then it means that the ends of the folded filter material are formed as closed sheet metal sections for the realization of baffle plates.

The priority application, German Patent Application Number 10 2009 015 217.2, filed on Mar. 31, 2009 is incorporated by reference herein.

1. A filter device for filtering a gas flow having a wound or folded filter material web, wherein at least one end of the filter material web is connected to a closed sheet metal section or forms such a section, wherein the closed sheet metal section has at least one recess for the inflow or outflow of gas into or out of the filter device.

2. The filter device according to claim 1, wherein the wound filter material web forms a hollow cylindrical winding body of the filter device, wherein the closed sheet metal section forms the inner or outer shell surface of the winding body or at the least a part thereof.

3. The filter device according to claim 1, wherein both ends of the filter material web are each one connected to a closed sheet metal section respectively.

4. The filter device according to claim 2, wherein both ends of the filter material web are each one connected to a closed sheet metal section respectively, wherein the one sheet metal section forms the inner, and the other sheet metal section forms the outer shell surface of the hollow cylindrical winding body.

5. The filter device according to claim 3, wherein the recesses, which are each formed in the two sheet metal sections respectively, are designed off-set to each other in the two sheet metal sections.

6. The filter device according to claim 2, wherein both ends of the filter material web are each one connected to a closed sheet metal section respectively, wherein the recesses, which are each formed in the two sheet metal sections respectively, are designed off-set to each other in the two sheet metal sections, wherein the off-set takes place in such a way that the recesses are off-set to each other in the longitudinal direction of the hollow cylindrical winding body.

7. The filter device according to claim 1, wherein as recess at least one gas passage opening is provided in the closed sheet metal section.

8. The filter device according to claim 1, wherein as recess at least one material cut-out or indentation on the edge is provided in the closed sheet metal section.

9. The filter device according to claim 1, wherein the filter material web has a metallic filter material.

10. The filter device according to claim 1, wherein the sheet metal section or sections form one piece with the filter material web.

11. The filter device according to claim 10, wherein the filter device has a sheet metal strip, wherein the sheet metal strip in the area of the filter material web is stamped and/or embossed and/or forms three-dimensional structural elements such that the filter material web in its wound state acts as filter, whereas the sheet metal strip in the area of the sheet metal sections is formed closed except for the at least one recess for the inflow or outflow of gas.

12. The filter device according to claim 1, wherein the sheet metal section or sections represent separately manufactured parts, which are connected to the filter material web.

13. The filter device according to claim 12, wherein the filter material web has at least one expanded metal sheet.

14. The filter device according to claim 1, wherein the filter material web has several material layers lying one on top of the other, which are wound together.

15. A gas generator of a vehicle occupant protection device, wherein a filter device for filtering a gas flow having a wound or folded filter material web, wherein at least one end of the filter material web is connected to a closed sheet metal section or forms such a section, wherein the closed sheet metal section has at least one recess for the inflow or outflow of gas into or out of the filter device.
